(19) United States
(12) Patent Application Publication
(10) Pub. No.: US 2019/0085793 A1
(43) Pub. Date: Mar. 21, 2019

(54) Method and apparatus for scalable, high volume accelerant gas (AG) generation for high capacity internal combustion engines (ICE)

(71) Applicant: Sven O. Tjelta, North Saanich (CA)

(72) Inventor: Sven O. Tjelta, North Saanich (CA)

(73) Assignee: Empire Hydrogen Energy Systems Inc., Sidney (CA)

(21) Appl. No.: 15/998,235

(22) Filed: Feb. 13, 2017

Related U.S. Application Data
(60) Provisional application No. 62/295,961, filed on Feb. 16, 2016.

(51) Int. Cl. F02M 25/12; F02B 43/02; F02B 43/10; C01B 3/04; C01B 13/02; C25B 1/06; C25B 9/04; C25B 9/06; C25B 15/02

(52) U.S. Cl. CPC F02M 25/12; F02B 43/02; F02B 43/10; C01B 3/042; F02B 2043/106; C25B 1/06; C25B 9/04; C25B 9/06; C25B 15/02; C01B 13/0207

(57) ABSTRACT

A high efficiency electrode consisting of an electrode plate having a top and a bottom. At least one saw-tooth opening is provided in the electrode plate. Each saw-tooth opening has a plurality of teeth extending upwardly toward the top of the electrode plate, the teeth being separated by v-shaped gaps. Bubbles travel quickly up the angled upslope of the teeth and are released when they reach an apex of each of the teeth.

### FIELD

There is described an electrode which was developed to improve the efficiency of electrolysis of water, but has wider application.

### BACKGROUND

Electrolysis of water is the decomposition of water (H20) into oxygen (02) and hydrogen gas (H2) due to an electric current being passed through the water. Referring to FIG. 1, an electrolysis cell 100 is illustrated. The main components of electrolysis cell 100 required to achieve electrolysis are:

An electrolyte 102: a substance, frequently an ion-conducting polymer that contains free ions, which carry electric current in the electrolyte.

A direct current (DC) electrical supply (a battery 104 has been illustrated): provides the energy necessary to create or discharge the ions in the electrolyte. Electric current is carried by electrons in the external circuit.

Two electrodes—an anode electrode 106 and a cathode electrode 108: electrical conductors that provide the physical interface between the electrolyte and the electrical circuit that provides the energy.

An electrical potential is applied across anode electrode 106 and cathode electrode 108 immersed in the electrolyte 102. Each electrode attracts ions that are of the opposite charge. Positively charged ions (cations) move towards the electron-providing (negative) cathode. Negatively charged ions (anions) move towards the electron-extracting (positive) anode. In pure water at the negatively charged cathode, a reduction reaction takes place, with electrons (e) from the cathode being given to hydrogen cations to form hydrogen gas.

The half reaction, balanced with acid, is:

Reduction at cathode: 2 W(aq)+2e−-- [symbol] H2(g)

At the positively charged anode, an oxidation reaction occurs, generating oxygen gas and giving electrons to the anode to complete the circuit:

Oxidation at anode: 2 H20(1)-- [symbol] 02(g)+4 H+(aq)+4e−

The same half reactions can also be balanced with base as listed below. To add half reactions they must both be balanced with either acid or base.

Cathode (reduction): 2 H20(1)+2e−-- [symbol] H2(g)+2 Ofr(aq)

Anode (oxidation):4 Ofr(aq)-- [symbol] 02(g)+2 H20(1)+4 e−

Combining either half reaction pair yields the same overall decomposition of water into oxygen gas 110 and hydrogen gas 112:

Overall reaction: 2 H20(1)-- [symbol] 2 H2(g)+02 (g)

The number of hydrogen molecules produced is thus twice the number of oxygen molecules. Assuming equal temperature and pressure for both gases, the produced hydrogen gas 112 has therefore twice the volume of the produced oxygen gas 110. The number of electrons pushed through the water is twice the number of generated hydrogen molecules and four times the number of generated oxygen molecules.

Due to the presence of hydrogen bubbles 114 and oxygen bubbles 116 in electrolyte 102 during water electrolysis, the potential drop between the cathode electrode 108 and anode electrode 106 in the two phase mixture electrolyte-gas bubbles will he increased. Electrolysis cell efficiency relates directly to electrode design.

### SUMMARY

There is provided an electrode which consists of an electrode plate having a top and a bottom. At least one saw-tooth opening is provided in the electrode plate. Each saw-tooth opening has a plurality of teeth extending upwardly toward the top of the electrode plate, the teeth being separated by v-shaped gaps.

As will hereinafter be further described, bubbles travel quickly up the angled teeth. The teeth create sharp pointed vertical transitions from upslope to downslope, which results in the release of bubbles as they reach an apex of each of the teeth.

When a single saw-tooth opening is used, single saw-tooth opening is positioned closer to the bottom than to the top of the electrode plate. The single saw-tooth opening is elongated and is spaced from and parallel to the bottom of the electrode plate.

There are various angles that have utility for the angle of the slope on the teeth. Beneficial results have been obtained with teeth angled at 30 degrees to vertical.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1, labelled as Prior Art, is a schematic diagram of an electrolysis cell.

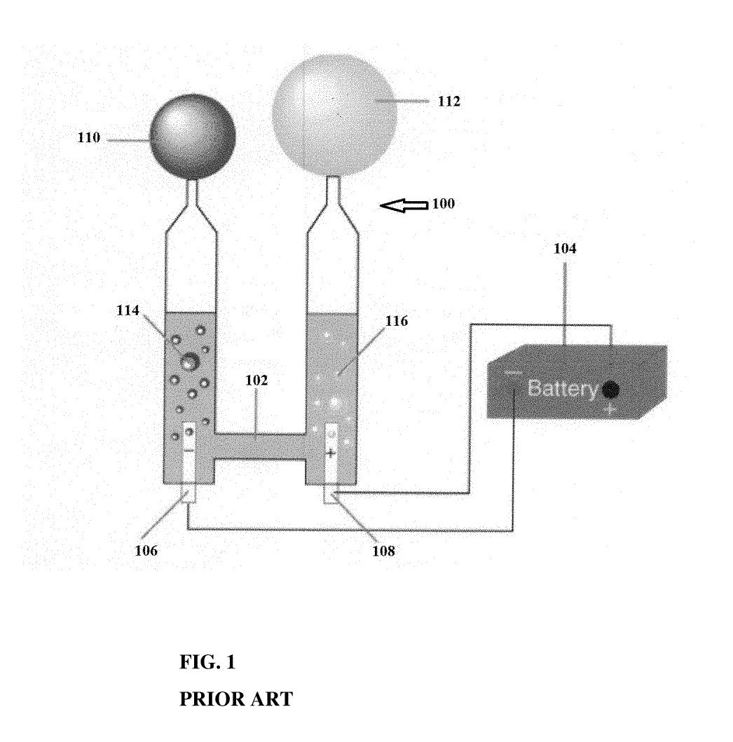

FIG. 2 is a side elevation view of an electrode.

### DETAILED DESCRIPTION

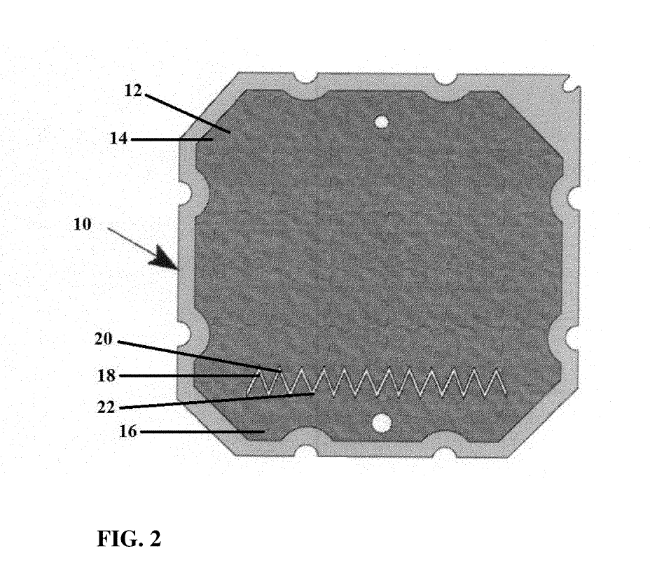

An electrode generally identified by reference numeral 10, will now be described with reference to FIG. 2.

### Structure and Relationship of Parts:

Referring to FIG. 2 electrode 10 consists of an electrode plate 12 having a top 14 and a bottom 16. A saw-tooth opening 18 is located towards bottom 16 of electrode plate 12. It will be understood that there may be more than one saw-tooth opening 18 in electrode plate 12. The number of saw-tooth openings 18 is dictated by the gas generation requirements for a particular application.

In this instance, 20 gauge 316 stainless steel was chosen as the material for electrode plate 12. It will be understood by those experienced in the art of electrolysis and electrode design, that there are a variety of other materials that would also be suitable.

By way of example, the illustrated saw-tooth opening 18 has:

a periodic structure of twenty three (23) teeth 20;

V-shaped gaps 22 between adjacent teeth 20 of between 1.63 and 2.25 mm;

Saw-tooth opening 18 is positioned between 25 and 40 mm above bottom 16 of electrode plate 12;

a length of saw-tooth opening 18 is approx. 15 mm;

a saw-tooth angle is approx. 30° from the vertical.

Based on this design, the “path length” of the saw-tooth is approx. 36 cm which when compared to a conventional 0.25″ diameter hole design gives the saw-tooth>500% size advantage over such (7.2 cm3 as compared to 1.27 cm3).

It will be understood that the size, periodicity, tooth width, of saw-tooth opening 18 are provided as an example only. The teachings regarding electrode efficiency are of general application and are not limited to particular dimensions of the example given.

### Operation:

Upon application of a voltage to electrode 10, when established in an electrolysis cell immersed in a suitable electrolyle (such as Potassium Hydroxide, KOH), bubbles of hydrogen and oxygen gas are formed. Bubbles form quickly on teeth 20 and V-gaps 22 of saw-tooth opening 18. Bubbles stay small and to travel quickly up the angled teeth 20 of saw-tooth opening 18 before being released upwards towards the cell output port.

It is to be noted that saw-tooth opening 18 has a vertical extent up electrode plate 12 created by teeth 20 and V-gaps 22. This results movement of bubbles travelling along teeth 20 up electrode plate 12. Teeth 20 create sharp pointed vertical transitions from upslope to downslope, which results in the release of bubbles. Saw-tooth opening 18 within electrode 12 is much more efficient than a simple hole structure. This improved bubble generation (and subsequent transport) results in electrode 10 providing improved bubble management capabilities and thus improved cell efficiency.

### Advantages:

The use of electrode 10 in an electrolysis cell provides the following advantages:

Enables better filling of the electrolysis cell with electrolyte covering more of the electrodes;

Increases small bubble generation;

Results in faster release of bubbles up the electrode plate; and

With faster bubble release resulting in lower transport resistance, better current density within the cell, improved efficiency and improved gas flow.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

1. A method and apparatus for generating hydrogen and oxygen accelerant gas for both gas and diesel internal combustion engines (ICE) for improvements in both fuel efficiency and reduced exhaust emissions. The apparatus in this invention comprises the following assemblies/subsystems of:
a connection to the ICE battery (or alternator) for a 12 v supply;
a Smart Controller (ECU) comprising a constant current design concept for controlling a hydrogen and oxygen accelerant gas generator assembly;
a hydrogen and oxygen accelerant gas generator comprising a cell plus electrolyte tank (single and double configurations);
a Blowback preventer/Dryer for trapping any water vapor from the oxy-generator as well as a retardant for any potential blowback issues from the ICE;
a connection to the air intake of the ICE;
connectivity between the ICE and the ECU for ICE real-time performance feedback and real-time control of the oxy-generator;
a ECU for real-time data recording of ICE performance and the real-time tuning of such for optimum ICE performance when employing this oxy-generation system.

2. The method of claim 1 includes the following steps:
connection of a ECU to either the ICE battery or alternator;
a ECU based on the control of high current (to 50 A and higher) to an oxy-generator assembly capable of high volumes of hydrogen and oxygen accelerant gas generation per minute;
under ECU direction, the generation of hydrogen and oxygen accelerant gas in an on-demand concept;
the passage of hydrogen and oxygen accelerant gas through an electrolyte tank;
the passage of hydrogen and oxygen accelerant gas through a Blowback preventer/dryer to trap any water vapor from the oxy-generator as well as a retardant for any potential blowback issues from the ICE;
the connection of the output of the Blowback preventer/dryer to the air intake of the ICE;
ECU functions based on sensor inputs from the ICE such as engine ON, oil pressure, CanBus data, etc.;
ECU functionality enabling real-time ICE data recording and tuning of this invention oxy-generator in sufficient volumes (liters/minute) optimized to ICE type, capacity, etc.;
ECU functionality enabling real-time assembling and transmission of ICE and vehicle performance data to a remote User.

3. The method of claim 2, wherein the step of removing water vapor and acting as a retardant for potential ICE blowback issues is through the use of our patented Blowback preventer/dryer;

4. The method of claim 2, whereby oxy-hydrogen gas generation is controlled through a high and constant current (50 A) design operating off a 12 v supply;

5. The method of claim 2, whereby a ECU is used for operating the high current (to 50 A) applied across the cell terminals to manage the volume of hydrogen and oxygen accelerant gas produced in the electrolytic cell;

6. The method of claim 5, whereby the ECU is scalable to very high currents (100 A) for very large capacity ICE;

7. The method of claim 5, whereby constant hydrogen and oxygen accelerant gas production is controlled and maintained through the ECU even as the level of electrolyte varies in the electrolytic cell and thus the concentration of the electrolytic agent varies over time;

8. The method and apparatus of claim 1, whereby this invention is applicable to a wide range of platform architectures and types including trucks, generators, marine platforms and the like whether these be 2- or 4-stroke designs/technologies;

9. The method and apparatus of claim 1 which is highly scalable in terms of hydrogen and oxygen accelerant gas generation capability and thus usage in wide range of ICE capacities (12 Liter and much higher);

10. The method and apparatus of claim 1, whereby its capabilities for hydrogen and oxygen accelerant gas are defined in terms of liters/minute;

11. The method of claim 1, whereby a ECU can record ICE data in real-time and then adjust hydrogen and oxygen accelerant gas generation optimized to ICE type/capacity/etc;

12. The method and apparatus of claim 1, whereby an ECU has embedded expert control processing and algorithms for real-time optimization of hydrogen and oxygen accelerant gas generation per ICE capacity/type/etc.;

13. The method and apparatus of claim 1, whereby a full and single enclosure enables a small physical footprint for system installation together with an enclosed environment enabling system operation in all environmental conditions;

14. The method and apparatus of claim 11, whereby the ECU can assemble and transmit ICE performance data including vehicle location etc. together with AG system details in real-time to a remote User.
